(19) United States
(12) Patent Application Publication
(10) Pub. No.: US 2003/0196363 A1
(43) Pub. Date: Oct. 23, 2003

(54) System information placard

(76) Inventors: Paul Amdahl, Sioux City, IA (US); Sheldon Adler, Sioux City, IA (US)

Correspondence Address: GATEWAY, INC., ATTN: SCOTT CHARLES RICHARDSON, 610 GATEWAY DRIVE, MAIL DROP Y-04, N. SIOUX CITY, SD, 57049, US

(21) Appl. No.: 10/420,444

(22) Filed: Apr. 22, 2003

Related U.S. Application Data
(60) Provisional application No. 60/374,725, filed on Apr. 22, 2002.

(51) Int. Cl. G09F 3/08

(52) U.S. Cl. 40/667

(57) ABSTRACT

An identification placard which may be used to identify the software loaded in a computer system. The identification placard includes a carrier that carries identification information, and is configured to be removably attached to a manufactured good. The carrier attaches in such a way that it is difficult to remove when the manufactured good is closed or operational but can be removed with or without the use of a tool when the manufactured good is opened for service. The carrier can be mounted on a less visible surface of the chassis, in plain sight or can be moved into a position where it is not visible during normal use, but readily available when needed by pulling it out, rotating it out or flipping it out.

### CROSS REFERENCE TO RELATED APPLICATIONS

The present application stems from provisional application No. 60/374,725 and is related to U.S. patent application Ser. No. 10/403,200 also assigned to Gateway, Inc. which is hereby incorporated by reference in its entirety.

### FIELD OF THE INVENTION

The present invention generally relates to the field of product identifiers for attachment to the product. More particularly, the invention involves a placard for removably attaching a software identifier to computer hardware.

### BACKGROUND OF THE INVENTION

Identification tags are an important component of many products. Such identification tags come in many forms, not limited to labels, stickers, painted, molder, screened or etched words or symbols. They identify the product, uniquely identify a particular unit by serial number or serve other purposes. They also provide other information such as authenticity data to thwart unlicensed use of software. In the past, placements of these identification tags have been somewhat of a nuisance. If the identification tag is placed on a visible surface where it is easy to find and use, it interferes with the aesthetics of the device. If the identification tag is placed on a rear surface, it is harder to find and use. Furthermore, in some cases where the identification tag has significant value such as when it serves as a license for an installed program such as an operating system, it becomes necessary to permit easy removal and replacement within a manufacturing environment while maintaining a more difficult removal in a retail environment.

### SUMMARY OF THE INVENTION

The present inventors recognized a number of special considerations for software identifiers which are configured to be attached to computer systems. Identifiers in the present context may be in the form of identification means, that is, placards, tags, labels, licenses, contracts, proof of purchase certificates, or other like identifying, documents. The identification means may serve as a license for valuable software, and sometimes carry the full value of that software. Due to this, installing said identification means too early in the manufacturing process may incur the cost of the software before the system is ready for sale. It is beneficial to configure the identification means so it is conducive to installation as late as practical in the manufacturing cycle, perhaps after the complete system is assembled, tested and loaded with software, or even at some time after reaching a retail sales outlet. For example, the identification means according to embodiments of the invention could be installed at the time the sale is made to a customer. Furthermore, systems can be shipped with multiple software packages loaded on its hard drive, then in the retail environment, all software packages may be deleted except for the package preferred by the customer, after which, an identification means pertaining to that software package may be attached. For example, a manufacturer might ship two versions of an operating system pre-installed on a system's hard drive, e.g., a home version and a more advanced professional version. Then, at the retail point of sale, the customer would select which operating system they would prefer and the alternate operating system would be deleted and an identification means attached indicating the selected operating system and any keys required to re-install or use the selected operating system.

Embodiments of the present invention are directed to an identification means that is either mounted in such a way that it can be removed and replaced during manufacture or service, or is mounted in such a way that it can be hidden during normal use of the device but made readily available when information on the identification means is required. As an example, the identification means can be removed or changed when a system or manufactured good is being serviced or upgraded. In one embodiment, the identification means is a carrier with a label that can be snapped onto a chassis, manufactured good or other work product during manufacture. The label may be attached to the carrier or be part of the carrier. This may be accomplished in many ways such as being glued to the carrier, printed on the carrier, etched or molded into the carrier or made as part of the carrier. Once the carrier is installed, it cannot be easily removed without opening the chassis or manufactured good and even then, may require a special tool for removal. Once the chassis is opened, the carrier can be easily removed and replaced with a different carrier. Again, this operation may require a special tool if added security is desired. In systems that are shipped with Certificates of Authenticity (COA), the present invention would permit a COA to be transferred from one system to another in cases where a manufacturing error is made, an order is canceled or returned or a customer changes their desire. If the mentioned added security is desired, the carrier may include a receptacle for a fastener that is engaged from the inside of the chassis where the fastener can be one of ordinary type such as a Philips-head or flat-head screw or the fastener can be of the type that cannot be removed with standard tools. Such fasteners are known in the industry and include star slots, twin points and the like.

In another embodiment, the identification means includes a label that is installed on a carrier or is part of a carrier that is normally hidden from view, but can be easily viewed when needed, perhaps during service, when restoring the system or restoring the software of which the label pertains. This carrier may slide out of the system chassis, rotate out of a hidden area or flip down. This carrier would not be easily removable from the chassis or manufactured good. Alternatively, the identification means uses the same carrier and label as above, except the carrier can be disengaged by a release mechanism located on the inside of the chassis, requiring a user or technician to open the chassis or manufactured good before the carrier and label can be easily removed.

It is to be understood that both the forgoing general description and the following detailed description are exemplary only and are not restrictive of the invention as claimed. The general functions of this invention may be combined in different ways to provide the same functionality while still remaining within the scope of this invention. The label carrier may be mounted or hidden in different locations or in different ways while still remaining within the scope of this invention.

### BRIEF DESCRIPTION OF THE DRAWINGS

The numerous advantages of the present invention may be better understood by those skilled in the art by reference to the accompanying figures in which:

FIG. 1 shows a carrier with label that snaps into a surface of a chassis and can be easily removed from the chassis, only when the chassis or manufactured good is opened.

FIG. 2 shows a detail view of the carrier with label.

FIG. 3 shows a carrier with label that snaps into a surface of a chassis or manufactured good and has provisions for a fastener that can be easily removed from the chassis from the inside by a technician having the appropriate removal tool.

FIG. 4 shows a detail view of the carrier with label that also provides a means to include a screw from the inside of the chassis that may require a special tool to remove.

FIG. 5 shows a carrier with label that can easily be extended out of a chassis when needed and pushed back into the chassis or manufactured good when finished.

FIG. 6 shows a carrier with label that can easily be rotated out of a chassis or manufactured good when needed and rotated back into the chassis when finished.

FIG. 7 shows a carrier with label that can easily be flipped out of a chassis or manufactured good when needed and flipped back into the chassis when finished.

FIG. 8 shows a carrier, possibly made of metal, that holds in place using springs and has a finger hole to allow a user to push the carrier out of the chassis after the chassis is opened for service.

FIG. 9 shows a carrier, possibly made of metal, having springs to hold it in place after being inserted into a chassis.

### DETAILED DESCRIPTION

Reference will now be made in detail to the presently discussed embodiments of the invention, some examples of which are illustrated in the accompanying drawings.

Referring now to FIG. 1, an identification means comprising a carrier mounted on a system in accordance with the present invention is shown. The label 130 can be made separate from the carrier 120 and mounted to carrier 120 or can be made as part of carrier 120. The label 130 is mounted, etched, glued, screened or attached in any known way to the carrier 120. The label 130 can be mounted before the carrier 120 is inserted into chassis 110 or after it is inserted. Carrier 120 has two spring tabs 140 and 150 that are pushed through slots 160 and 170 of chassis or manufactured good 110. Once tabs 140 and 150 are pushed completely into slots 160 and 170, the spring section opens enough to prevent removal from slots 160 and 170 of chassis 110. The entire operation of insertion can be performed when chassis or manufactured good 110 is open or closed, but once inserted, chassis or manufactured good 110 must be opened and the spring tabs 140 and 150 must be compressed to remove carrier 120.

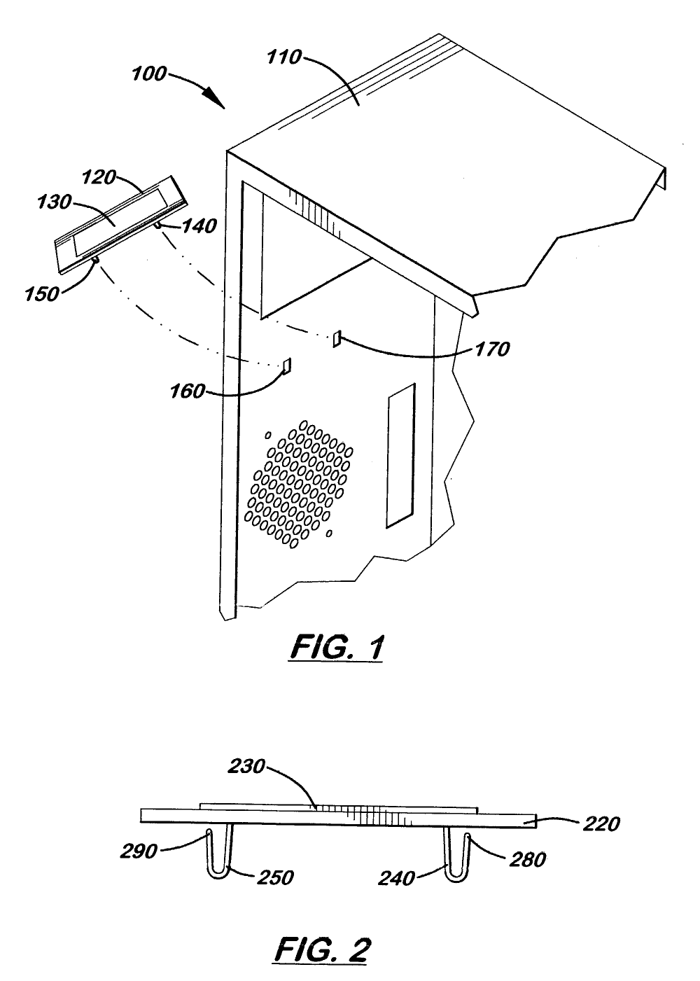

Referring now to FIG. 2, an expanded view of the label carrier shown in FIG. 1 in accordance to the present invention is shown. Carrier 220 has a label section 230 where the label can be attached in many ways or the label can be made as part of the carrier using methods known in the industry including molding, printing, screening or etching techniques. Carrier 220 also has two spring tabs 240 and 250. When carrier 220 is pushed through chassis or manufactured good 110, the spring edges 280 and 290 of spring tabs 240 and 250 compress to allow the spring tabs 240 and 250 to be inserted through slots 160 and 170 of chassis or manufactured good 110. Once spring edges 280 and 290 are inserted far enough into chassis 110 so that they clear the surface, spring edges 280 and 290 uncompress far enough so that carrier 220 cannot be removed from chassis or manufactured good 110 without manually compressing spring edges 280 and 290 sufficiently so that they can pass through slots 160 and 170. The operation of manually compressing can only be performed when the chassis is in the open position.

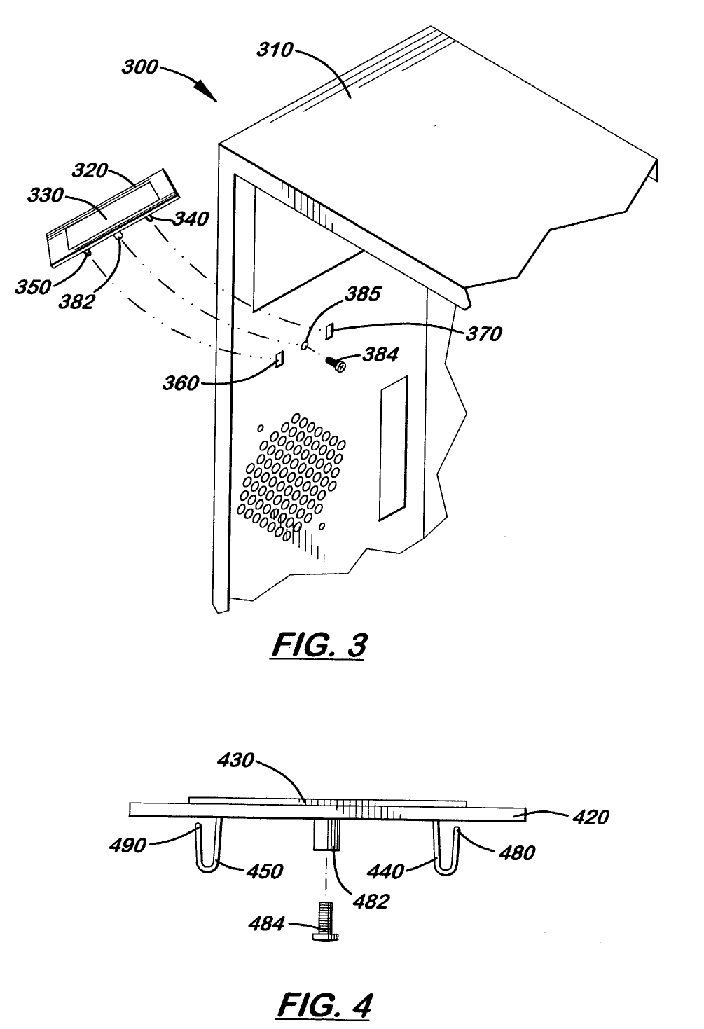

Referring now to FIG. 3, a carrier mounted on a system in accordance with the present invention is shown. The label 330 can be made separate from the carrier 320 and mounted to carrier 320 or can be made as part of carrier 320. The label 330 is mounted, etched, glued, screened or attached in any known way to the carrier 320. The label 330 can be mounted before the carrier 320 is inserted into chassis 310 or after if it is a separate component. Carrier 320 has two spring tabs 340 and 350 that are pushed through slots 360 and 370 of chassis or manufactured good 310. Once tabs 340 and 350 are pushed completely into slots 360 and 370, the spring section opens enough to prevent removal from slots 360 and 370 of chassis or manufactured good 310. Additionally, boss 382 is provided to accept screw 384 after insertion through chassis or manufactured good opening 385. Screw 384 can be of any type, but for added security it can be a security screw that has a head that requires a special driver for removal. The entire operation of insertion can be performed when chassis or manufactured good 310 is open or closed, but screw 384 can only be inserted when the chassis is opened. Once inserted, chassis or manufactured good 310 must be opened, screw 384 must be removed and the spring tabs 340 and 350 must be compressed to remove carrier 320.

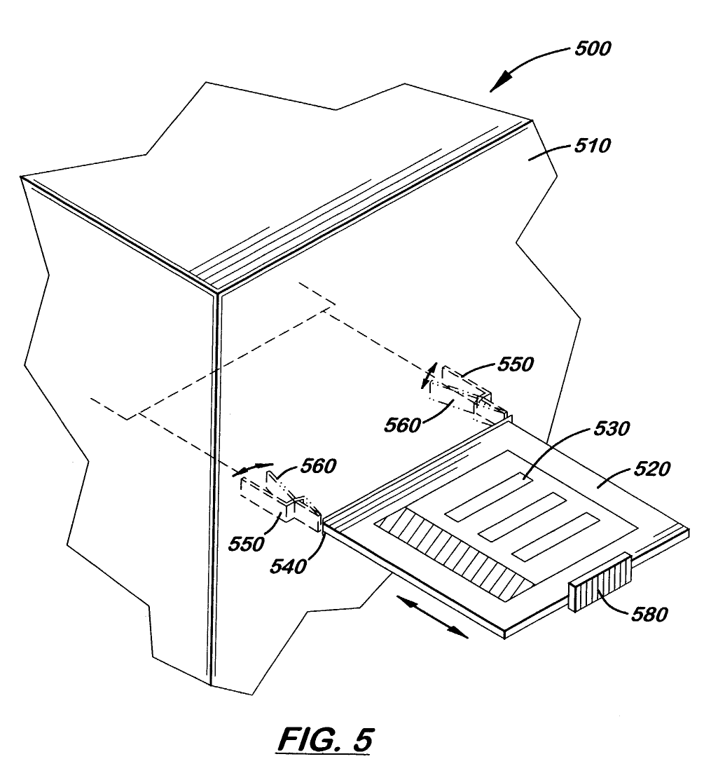

Referring now to FIG. 4, an expanded view of the label carrier shown in FIG. 3 in accordance to the present invention is shown. Carrier 420 has a label 430 attached, printed, mounted, etched or molded onto its surface. Carrier 420 has two spring tabs 440 and 450. When carrier 420 is pushed through chassis or manufactured good 310, the spring edges 480 and 490 of spring tabs 440 and 450 compress to allow the spring tabs 440 and 450 to be inserted through slots 360 and 370 of chassis or manufactured good 310. Once spring edges 480 and 490 are inserted far enough into chassis 310 so that they clear the surface, spring edges 480 and 490 uncompress far enough so that carrier 420 cannot be removed from chassis or manufactured good 310 without manually compressing spring edges 480 and 490 sufficiently so that they can pass through slots 360 and 370. Once carrier 420 is inserted in this manner, screw 484 is screwed into boss 482 to provide added security. Screw 484 can be any type of screw, but for added security, it may be of the type that requires a special driver for removal. The operation of removing screw 484 and manually compressing spring edges 480 and 490 can only be performed when the chassis is in the open position.

Referring now to FIG. 5, a carrier in accordance with the present invention. Label 530 is attached, printed, mounted, etched, screened or molded onto the surface of carrier 520. Carrier 520 has two spring tabs 550. During manufacture, carrier 520 is inserted into opening 540 of chassis 510 by compressing spring tabs 550 to a position shown by 560. Once fully inserted into slot 540, spring tabs 550 expand and prevent carrier 520 from being removed from the outside of chassis 510. Carrier 520 can be removed by opening chassis 510 and compressing spring tabs 550 to push carrier 520 through slot 540. Pull-tab 580 is provided so that the user can extend carrier 520 and view label 530.

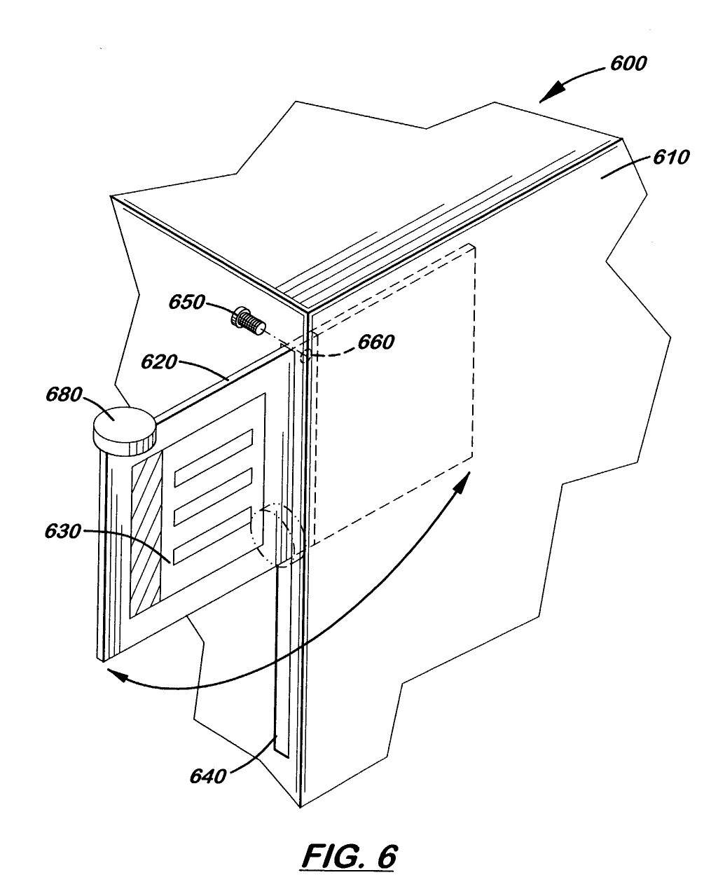

Referring now to FIG. 6, a carrier in accordance with the present invention. Label 630 is attached, printed, mounted, etched, screened or molded onto the surface of carrier 620. During manufacture, carrier 620 is attached to chassis or manufactured good 610 by inserting it through slot 640 and passing screw 650 through hole 660 from the inside of chassis or manufactured good 610. Once attached, carrier 620 can be swiveled out of chassis or manufactured good 610 to let the user view contents of label 630. Carrier 620 can only be removed by opening chassis or manufactured good 610 and removing screw 650. Screw 650 can be of any type, but preferably a shoulder screw with the surface that interfaces with hole 660 being substantially smooth.

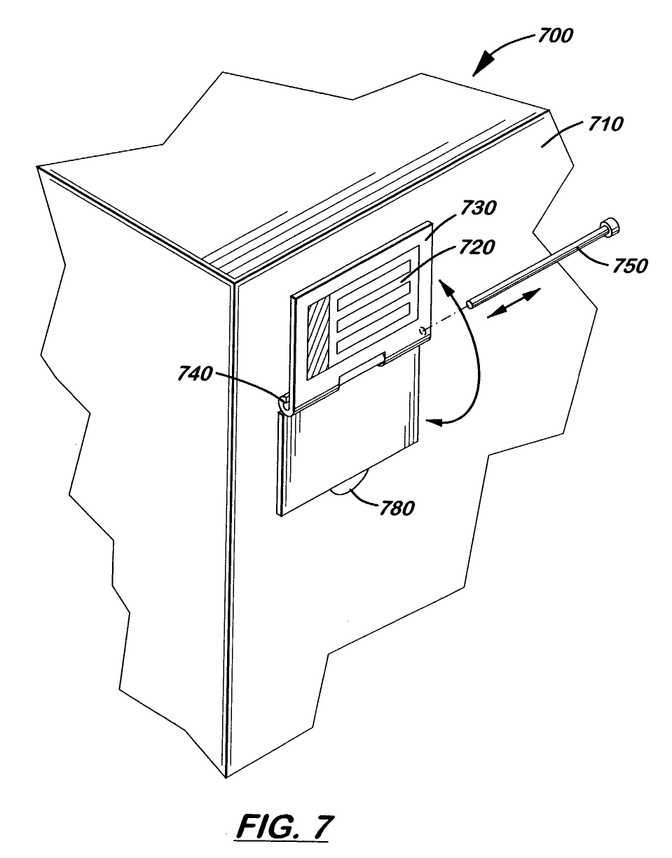

Referring now to FIG. 7, a carrier in accordance with the present invention. Label 720 is attached, printed, mounted, etched, screened or molded onto the surface of carrier 730. Carrier 730 is attached to chassis or manufactured good 710 by way of a hinge 740 and hinge pin 750. Carrier 730 can be positioned in its open position to show label 720 or hinged into its closed position to hide label 720 for aesthetic reasons. Pin 750 can only be inserted into hinge 740 when the chassis is opened to prevent undesired removal of carrier 730 and label 720.

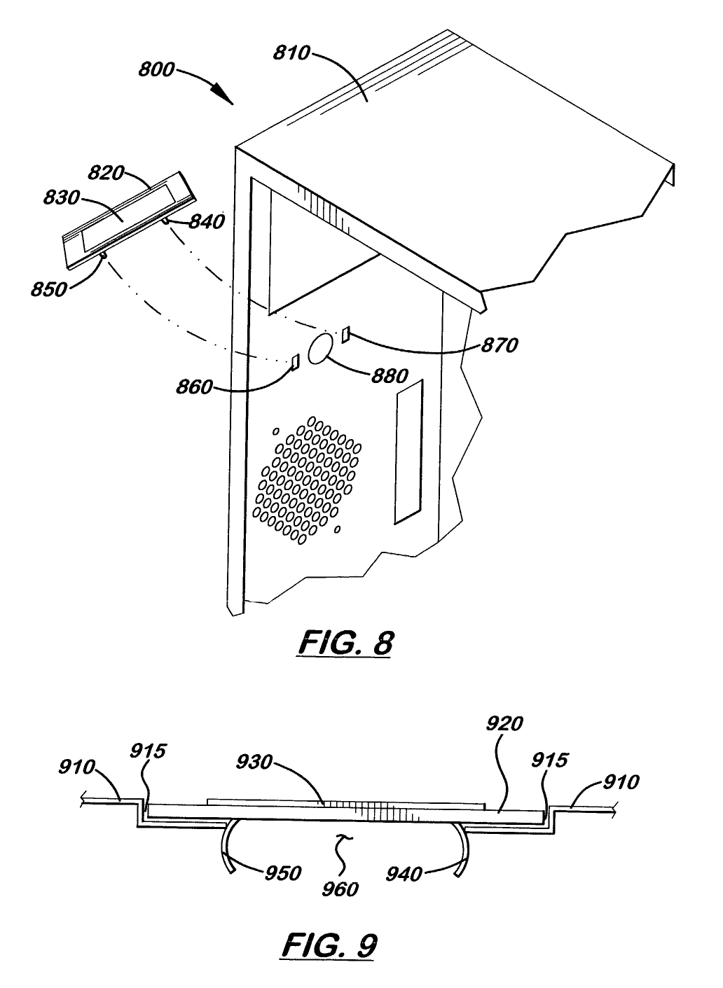

Referring now to FIG. 8, an identification means comprising a carrier mounted on a system in accordance with the present invention is shown. The label 830 can be made separate from the carrier 820 and mounted to carrier 820 or can be made as part of carrier 820. The label 830 is mounted, etched, glued, screened or attached in any known way to the carrier 820. The label 830 can be mounted before the carrier 820 is inserted into chassis 810 or after it is inserted. Carrier 820 has two spring tabs 840 and 850 that are pushed through slots 860 and 870 of chassis or manufactured good 810. Once tabs 840 and 850 are pushed completely into slots 860 and 870, the springs expand to prevent removal from slots 860 and 870 of chassis 810. In this embodiment, carrier 820 might be made of metal or other stiff material and made very thin so that it would be hard for someone to remove carrier 820 from chassis 810 without opening chassis 810 for service and pushing from the inside. Finger hole 880 is provided so that after chassis 810 is opened for service, pressure can be applied behind carrier 820 to overcome springs 850 and 860 and remove carrier 820 from chassis 810. The entire operation of insertion can be performed when chassis or manufactured good 810 is open or closed, but once inserted, chassis or manufactured good 810 must be opened to apply force to the back of carrier 820 to remove carrier 820. To make it more difficult to remove carrier 820 from chassis 810 when chassis 810 is not open for service, carrier 820 can be positioned in an indentation so that its edges are not flush with the surface of chassis 810, further preventing unwanted removal before service access.

Referring now to FIG. 9, an expanded view of the label carrier shown in FIG. 8 in accordance to the present invention is shown. Carrier 920 has a label section 930 where the label can be attached in many ways or the label can be made as part of the carrier using methods known in the industry including molding, printing, screening or etching techniques. Carrier 920 also has two springs 940 and 950. When carrier 920 is pushed through chassis or manufactured good 910, the springs 940 and 950 compress to allow insertion through slots 960 and 970 of chassis or manufactured good 910. Once springs 940 and 950 are inserted far enough into chassis 910, carrier 920 cannot easily be removed from chassis or manufactured good 910 without opening chassis 910 for service and pushing carrier 920 from the inside. Finger hole 960 is provided to allow pushing from the inside after chassis 910 is opened for service. To prevent unwanted removal before chassis 910 is open for service, carrier 920 can be made very thin and flush with chassis 910 to make it difficult to remove carrier 920 using a wedge such as a screw driver. To make it even more difficult, carrier 920 can be located in well 915 within chassis 910, providing more protection from being pried out of chassis 910.

Although the invention has been described with a certain degree of particularity, it should be recognized that elements thereof may be altered by persons skilled in the art without departing from the spirit and scope of the invention. There are many methods of attaching the label to the carrier, many of which are explained, but this invention is not limited to the methods cited. It is believed that the System Information Placard of the present invention and many of its attendant advantages will be understood by the forgoing description, and it will be apparent that various changes may be made in the form, construction and arrangement of the components thereof without departing from the scope and spirit of the invention or without sacrificing all of its material advantages, the form herein before described being merely an explanatory embodiment thereof, and further without providing substantial change thereto. It is the intention of the claims to encompass and include such changes.

What is claimed is:

1. An identification device comprising:
a carrier for carrying identification information;
an attachment means to attach said carrier onto a manufactured good such that said carrier can be easily removed from said good only after service access to said manufactured good is activated.

2. The device of claim 1, wherein said attachment means comprises at least one spring clip that compresses during insertion into said manufactured good and expands to prevent removal once inserted into said manufactured good.

3. The device of claim 2, wherein said attachment means includes a threaded hole and after said carrier is inserted into said manufactured good, a screw can be inserted through said manufactured good and into said threaded hole.

4. The device as claimed in claim 3, wherein said screw has a flat-slot head.

5. The device as claimed in claim 3, wherein said screw has a Philips head.

6. The device as claimed in claim 3, wherein said screw is a security screw.

7. An identification device comprising:
a carrier for carrying identification information having at least one spring member;
a manufactured good having an opening for accepting said carrier, said opening being wide enough to allow insertion of said carrier when said at least one spring member is compressed but small enough to prevent removal when said at least one spring member not compressed.

8. An identification device comprising:
a carrier for carrying identification information having a pivot hole;
a slot in a manufactured good large enough to allow said carrier to pivot in and out of said slot;
a pivot screw inserted from inside said manufactured good through said pivot hole allowing said carrier to pivot in and out of said manufactured good.

9. A device as claimed in claim 8, wherein said manufactured good is a computer chassis.

10. An identification device comprising:
a carrier for carrying identification information;
a hinge on one edge of said carrier;
a manufactured good;
a hinge pin that is inserted from inside said manufactured good through said hinge and attaches said carrier to said manufactured good.

11. A device as claimed in claim 10, wherein said manufactured good is a computer chassis.

12. A manufactured good comprising:
a enclosure having at least on slot;
a carrier for carrying identification information, said carrier having at least one spring clip that can be compressed for insertion into said slot, said spring clip expanding after insertion into said slot to secure it to said enclosure, requiring said enclosure to be opened for service before said spring clip can be compressed for removal.

13. A method of installing an identification device having at least one spring clip into a manufactured good having at least one slot comprising:
Compressing said at least one spring clip so that said at least one spring clip fits within said at least one slot;
Pushing said at least one spring clip far enough into said at least one slot until said at least one spring clip expands such that said identification label cannot be easily removed from said manufactured good without compressing said at least one said spring clip from within said manufactured good.

14. A method as claimed in claim 13, wherein said manufactured good is a computer chassis.

15. A method of transferring an identification device from a first manufactured good to a second manufactured good, each having at least one slot to accommodate said identification device, comprising:
Opening an access panel on said first manufactured good;
Removing said identification device from said first manufactured good by engaging an internal release mechanism;
Inserting said identification label into said at least one slot of said second manufactured good.

16. A method as claimed in claim 15 wherein said method of engaging an external release mechanism includes compressing at least one spring member so that it clears said at least one slot of said first manufactured good.

17. A method as claimed in claim 15 wherein said method of engaging an external release mechanism includes removing a hinge pin from the inside of said first manufactured good.

18. A method as claimed in claim 15 wherein said method of engaging an external release mechanism includes removing a pivot pin from the inside of said first manufactured good.
